(19) United States
(12) Patent Application Publication
(10) Pub. No.: US 2026/0164073 A1
(43) Pub. Date: Jun. 11, 2026

(54) INTERFACE INTERACTION

(71) Applicant: Beijing Zitiao Network Technology Co., Ltd., Beijing (CN)

(72) Inventors: Jiahui YANG, Beijing (CN); Yang Wang, Beijing (CN)

(21) Appl. No.: 19/414,191

(22) Filed: Dec. 9, 2025

(30) Foreign Application Priority Data
Dec. 10, 2024 (WO) PCT/CN2024/138274

(51) Int. Cl. H04N 21/262; G06F 3/04842

(52) U.S. Cl. CPC H04N 21/26291; G06F 3/04842

(57) ABSTRACT

According to embodiments of the disclosure, a method, apparatus, device and storage medium for interface interaction are provided. The method includes: presenting a first content item associated with a first set of media contents in a target interface, where presenting the first content item includes: displaying at least a first media content in the first set of media contents and identification information of at least one user associated with the first set of media contents; obtaining a second media content associated with a current user in response to receiving an addition request associated with the first set of media contents; and updating the first content item by adding the second media content into the first set of media contents.

### CROSS-REFERENCE

This application claims priority to International Patent Application No. PCT/CN2024/138274, filed on Dec. 10, 2024, and entitled “method, apparatus, device, and computer-readable storage medium for interface interaction”, the disclosure of which is incorporated herein by reference in its entirety.

### FIELD

Example embodiments of the present disclosure generally relate to the field of computers, and more particularly, to interface interaction.

### BACKGROUND

With the popularity of social networks, social applications have become an important platform on which people daily communicate. On these platforms, users may not only keep in touch with their friends, but are increasingly inclined to create content together. Co-creating content, especially between friends, has become a new highlight of social applications.

### SUMMARY

In a first aspect of the present disclosure, a method for interface interaction is provided. The method includes: presenting a first content item associated with a first set of media contents in a target interface, where presenting the first content item includes: displaying at least a first media content in the first set of media contents and identification information of at least one user associated with the first set of media contents; obtaining a second media content associated with a current user in response to receiving an addition request associated with the first set of media contents; and updating the first content item by adding the second media content into the first set of media contents.

In a second aspect of the present disclosure, an apparatus for interface interaction is provided. The apparatus includes: a first presentation module configured to present a first content item associated with a first set of media contents in a target interface, where presenting the first content item includes: displaying at least a first media content of the first set of media contents and identification information of at least one user associated with the first set of media contents; an obtaining module configured to obtain a second media content associated with a current user in response to receiving an addition request associated with the first set of media contents; and an updating module configured to update the first content item by adding the second media content to the first set of media contents.

In a third aspect of the present disclosure, an electronic device is provided. The device includes at least one processor; and at least one memory coupled to the at least one processor and storing instructions for execution by the at least one processor. The instructions, when executed by the at least one processor, cause the device to perform the method of the first aspect.

In a fourth aspect of the present disclosure, a computer readable storage medium is provided. The computer readable storage medium stores a computer program thereon, and the computer program is executable by a processor to implement the method in the first aspect.

It should be appreciated that what is described in this Summary is not intended to limit critical features or essential features of embodiments of the disclosure, nor is it intended to limit the scope of the disclosure. Other features of the present disclosure will become readily appreciated from the following description.

### BRIEF DESCRIPTION OF THE DRAWINGS

The above and other features, advantages, and aspects of various embodiments of the present disclosure will become more apparent with reference to the following detailed description taken in conjunction with the accompanying drawings. In the drawings, the same or similar drawing reference signs denote the same or similar elements, where:

FIG. 1 illustrates a schematic diagram of an example environment in which embodiments according to the present disclosure may be implemented;

FIGS. 2A-2F illustrate example interfaces according to some embodiments of the present disclosure;

FIG. 3 illustrates a flowchart of an example process for interface interaction according to some embodiments of the present disclosure;

FIG. 4 illustrates a schematic structural block diagram of an example apparatus for interface interaction according to some embodiments of the present disclosure; and

FIG. 5 illustrates a block diagram of an electronic device capable of implementing various embodiments of the present disclosure.

### DETAILED DESCRIPTION

Embodiments of the present disclosure will be described in more detail below with reference to the accompanying drawings. Although certain embodiments of the present disclosure are shown in the drawings, it should be understood that the present disclosure may be implemented in various forms and should not be construed as limited to the embodiments set forth herein, but rather, these embodiments are provided for a thorough and complete understanding of this present disclosure. It should be understood that the drawings and embodiments of the present disclosure are for illustrative purposes only and are not intended to limit the scope of the present disclosure.

It is important to note that heading of any section/subsection provided in this article is not limiting. Various embodiments are described throughout herein, and any type of embodiments can be included under any section/subsection. Furthermore, the embodiments described in any section/subsection may be combined in any way with any other embodiments described in the same section/subsection and/or in a different section/subsection.

In the description of embodiments of the present disclosure, the term “including” and similar expressions shall be understood as an open-ended inclusion, that is, “including but not limited to”. The term “based on” should be understood to mean “based at least in part on.” The term “an embodiment” or “the embodiment” shall be understood to mean “at least one embodiment”. The term “some embodiments” should be understood as “at least some embodiments”. Other explicit and implicit definitions may be included below. The terms “first”, “second”, etc. may refer to different or the same object. Other explicit and implicit definitions may be included below.

Embodiments of the present disclosure may involve user data, the obtaining and/or use of data, etc. These aspects comply with corresponding laws, regulations and relevant regulations. In the embodiments of this disclosure, collection, obtaining, processing, processing, forwarding, use, etc. of all data are performed with the user's knowledge and confirmation. Accordingly, when implementing each embodiment of the present disclosure, users should be informed of the type, scope of use, usage scenarios, etc. that may be involved in the data or information and obtain their authorization through appropriate means in accordance with relevant laws and regulations. The specific notification and/or authorization methods may vary according to the actual situation and application scenarios, and the scope of the present disclosure is not limited in this regard.

In the technical solution in this description and embodiments, if the processing of personal information is involved, the processing will be carried out on the premise that there is a basis of legality (e.g., consent of the subject of the personal information is obtained or it is necessary to fulfill a contract, etc.), and the processing will be carried out only within the scope of the stipulations or agreements. The user refusing to process personal information other than that which is necessary for the basic functions will not affect the user's use of the basic functions.

As mentioned briefly above, with the popularity of social networks, social applications have become the important platform on which people daily communicate. On these platforms, users may not only keep in touch with their friends, but are increasingly inclined to create content together. Creating content, especially between friends, has become the new highlight of social application.

Embodiments of the present disclosure provide a solution for interface interaction. The solution includes presenting a first content item associated with a first set of media contents in a target interface, where presenting the first content item includes: displaying at least a first media content in the first set of media contents and identification information of at least one user associated with the first set of media contents; obtaining a second media content associated with a current user in response to receiving an addition request associated with the first set of media contents; and updating the first content item by adding the second media content into the first set of media contents.

In this way, embodiments of the present disclosure can support users to collaboratively create on the first set of media contents, thereby improving the efficiency of creation of the first set of media contents.

Various example implementations of the solution are described in further detail below with reference to the accompanying drawings.

### Example Environment

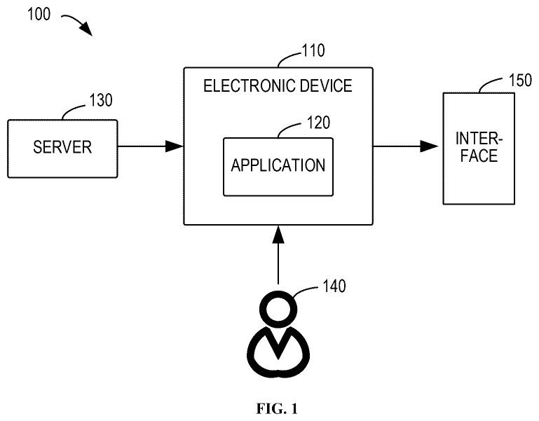

FIG. 1 illustrates a schematic diagram of an example environment 100 in which embodiments of the present disclosure can be implemented. As shown in FIG. 1, example environment 100 may include an electronic device 110.

In this example environment 100, an application 120 that supports interface interaction may run on an electronic device 110. The application 120 may be any suitable type of application for interface interaction, examples of which may include but are not limited to: a social application, a shopping application, content sharing application, video play application or other appropriate applications. A user 140 may interact with the application 120 via the electronic device 110 and/or its attached devices.

In the environment 100 of FIG. 1, if the application 120 is in an active state, the electronic device 110 may present an interface 150 for supporting interface interaction through the application 120.

In some embodiments, the electronic device 110 communicates with a server 130 to enable provision of services to the application 120. The electronic device 110 may be any type of a mobile terminal, a fixed terminal or a portable terminal, including a mobile phone, a desktop computer, a laptop computer, a notebook computer, a netbook computer, a tablet computer, a media computer, a multimedia tablet, a palmtop computer, a portable game terminal, a VR/AR equipment, a Personal Communication System (PCS) device, a personal navigation device, a Personal Digital Assistant (PDA), an audio/video player, a digital cameras/camcorder, a positioning device, a TV receiver, a radio receiver, an e-book device, a gaming device, or any combination of the foregoing, including accessories and peripherals for these devices or any combination thereof. In some embodiments, the electronic device 110 can also support any type of interface targeted to the user (such as “wearable” circuitry, etc.).

The server 130 may be an independent physical server, or a server cluster or distributed system consisted of a plurality of physical servers, or a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system/server such as a mainframe, an edge computing node, a computing device in a cloud environment, or the like. The server 130 may provide background services for the applications 120 in the electronic device 110 that support virtual scenarios.

A communication connection may be established between the server 130 and the electronic device 110. Communication connections can be established via wired or wireless manner. Communication connections may include but are not limited to Bluetooth connections, mobile network connections, Universal Serial Bus (USB) connections, Wireless Fidelity (WIFI) connections, etc. The embodiments of the present disclosure are not limited in this regard. In the embodiments of the present disclosure, the server 130 and the electronic device 110 can implement signaling interaction through the communication connection therebetween.

It should be understood that the structure and function of various elements in environment 100 are described for illustrative purposes only and do not imply any limitation on the scope of the present disclosure.

Some example embodiments of the present disclosure will continue to be described below with reference to the accompanying drawings.

### Example Interactions

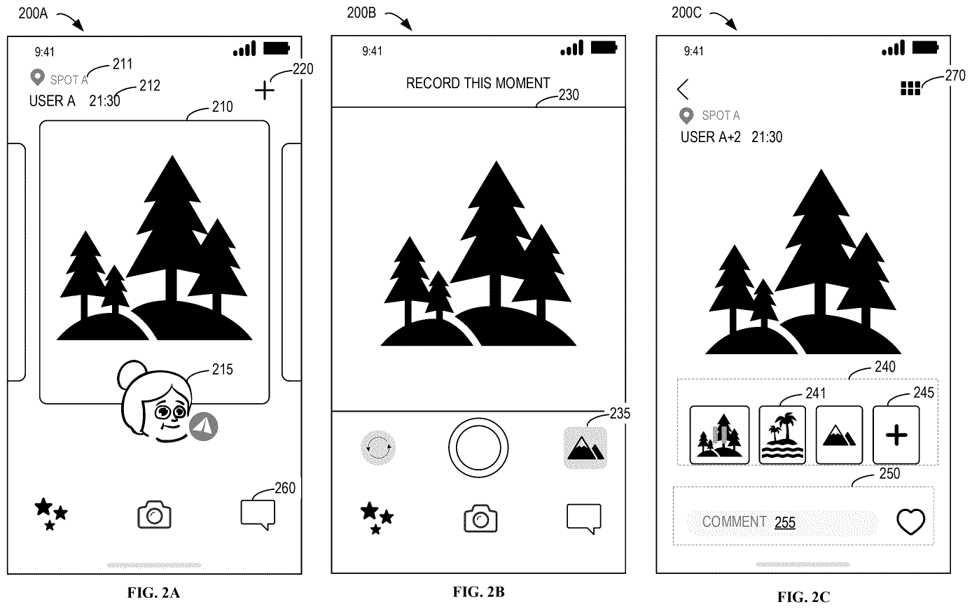

FIGS. 2A-2F illustrate example interfaces 200A-200F according to some embodiments of the disclosure. The interfaces 200A-200I may, for example, be provided by the electronic device 110 shown in FIG. 1.

In some embodiments, the electronic device 110 presents a first content item associated with a first set of media contents in a target interface. Presenting the first content item includes: displaying at least a first media content in the first set of media contents and identification information of at least one user associated with the first set of media contents.

As an example, as shown in FIG. 2A, FIG. 2A illustrates a schematic diagram of an embodiment of interface interaction according to the present disclosure. The electronic device 110 may present an interface 200A including a plurality of sets of media content. The electronic device 110 may present the first set of media contents 210 in the interface 200A. The first set of media contents 210 includes at least one content (e.g., the first content item), for example, the first content item may be image content or video content uploaded by the poster of the first media content 210. The interface 200A may also include a component 215 including identification information of at least one user which is associated with the first media content 210. Here, the component 215 includes the identification information of the poster of the first set of media contents 210. For example, the identification information may be an avatar of the poster of the first set of media contents 210.

The electronic device 110 may also present location information 211 associated with the first content item and poster information 212 of the first set of media contents in the interface 200A. The location information 211 may be determined by the electronic device 110 based on the first content item, or be a location set by the poster of the first set of media contents himself or herself.

In some embodiments, the first set of media contents is created based on a configuration operation of target users. As an example, the electronic device 110 may obtain the configuration operation of the poster of the first set of media contents 210, when the first set of media contents 210 is posted. For example, the configuration operation may be the editing permission of the first set of media contents 210, the posting time of the first set of media contents 210, the background music of the first set of media contents 210, etc. The editing permissions of the first set of media contents 210 indicates allowing to add or delete a set of users of the first set of media contents 210. For example, such a set of users may be friends of the poster of the first set of media contents 210.

In some embodiments, the electronic device 110 obtains a second media content associated with the current user in response to receiving an addition request associated with the first set of media contents.

As an example, as shown in FIG. 2A to FIG. 2B, the electronic device 110 may represent the interface 200B after receiving the addition request. For example, the interface 200B may be a shooting interface of media content. The interface 200B includes a camera component 230 and an image selection component 235. The electronic device 110 may obtain the shot images (i.e., the second media content) presented in the camera component 230. In some scenarios, the electronic device 110 may also represent the selection interface of media content in response to the selection of the user 140 for the image selection component 235. The electronic device 110 may obtain the selected target image and/or video (i.e., the second media content), after the target image and/or video in the selection interface of media content are selected by the user 140.

In some embodiments, the electronic device 110 may obtain the second media content associated with the current user in response to the current user matching the user scope indicated by the configuration operation. The user scope indicates uses allowed to add media content to the first set of media contents.

As an example, after the electronic device 110 obtains the second media content associated with the user (i.e., the current user), the electronic device 110 may make permission verification of the current user to verify whether the user 140 has the editing permission of the first set of media contents 210.

In some embodiments, the electronic device 110 may present an addition entry corresponding to the first set of media contents in the target interface or the viewing interface of the first set of media contents.

As an example, as shown in FIG. 2A, the electronic device 110 may present the addition entry 220 corresponding to the first set of media contents in interface 200A.

In some scenes, as shown in FIG. 2C, after receiving the selection of the user 140 for the first set of media contents 210, the electronic device 110 may present the interface 200C. The interface 200C may be the viewing interface of the first set of media contents 210. The interface 200C includes a content selection control 240. The content selection control 240 includes an addition entry 245.

The electronic device 110 may obtain the addition request associated with the first set of media contents in response to the selection of the addition entry after the addition entry being presented. As an example, when the addition entry 245 is selected, the electronic device 110 may present the shooting interface of media content as shown in FIG. 2B to obtain media content uploaded or shot by the user 140. In this way, it can be more convenient to make the creation of media content for users.

In some embodiments, the electronic device 110 may present the viewing interface of the first set of media contents in response to a first operation to the first content item. Further, the electronic device 110 may play the first set of media contents in a viewing interface. As an example, as shown in FIG. 2C, the electronic device 110 may present the interface 200C, after receiving the selection of the first set of media contents by users. The electronic device 110 may automatically play the first set of media contents 210 when the interface 200C is presented.

In some embodiments, the first set of media contents includes a plurality of media content. The electronic device 110 may play the first set of media contents based on a target play order. The target play order is determined based on associated information of the plurality of media contents. As an example, the electronic device 110 may rank the plurality of media contents in the first set of media contents based on associated information of the plurality of media contents. The associated information may be for example, the upload sequence, the shooting time or subject of the plurality of media contents. In some scenarios, the electronic device 110 may rank the plurality of media contents in a reverse order based on the upload order of the plurality of media contents to make the last uploaded media content be played first.

In some scenarios, the electronic device 110 may determine the target play order based on history interaction information of users and the subjects of the plurality of media contents. The history interaction information is requested from users under the premise that the users have known.

In some embodiments, the electronic device 110 may present a set of image identifications corresponding to the first set of media contents in the viewing interface. As an example, as shown in FIG. 2C, the electronic device 110 may present a set of preview components (i.e., image identifications) corresponding to the plurality of media contents of the first set of media contents in the interface 200C, such as the preview component 241.

Further, the electronic device 110 may present the media content corresponding to the target image identification in the viewing interface in response to the selection of the target image identification in a set of image identifications. As an example, in response to the selection of the preview component 241 (i.e., the target image identification) by the user 140, the electronic device 110 may switch to present the media content corresponding to the preview component 241.

In some embodiments, the electronic device 110 may provide an interaction control corresponding to the currently playing target media content in the viewing interface. As an example, as shown in FIG. 2C, the electronic device 110 may present the interaction control 250 corresponding to the currently playing target media content in the viewing interface 200C. The interaction control 250 includes a comment component 255. The electronic device 110 may obtain the comment content input via the comment component 255 by the user 140.

Further, in response to receiving an interaction operation associated with the target media content via interaction control, the electronic device 110 may trigger to send a remind message associated with the interaction operation to the user corresponding to the target content.

As an example, the interaction operation, for example, may be the comment operation or like operation for the target media content by the user 140. The electronic device 110 may trigger to send a remind message associated with the interaction operation to the poster of the target media content when receiving the interaction operation associated with the target media content. If the interaction operation is the comment operation triggered by the user 140, the electronic device 110 then may trigger sending the remind message that the target content has been commented to the poster of the target content. In some scenes, the remind message may also be the comment content input via the comment component 255 by the user 140.

In some embodiments, the electronic device 110 may represent the interaction information corresponding to the currently played target media in response to receiving a second operation from the viewing interface.

As an example, as shown in FIG. 2C, when receiving the second operation, the electronic device 110 may present an interface 200D as shown in FIG. 2D. The interface 200D includes a plurality pieces of interaction information associated with the target media content (e.g., comment content 1, comment content 2) and the identification information of the user associated with the plurality of interaction information. The second operation, for example, may be touch-and-hold, click or other suitable operation for the target media content. In such way, the user can receive the interaction information associated with target media content in time, thereby improving the efficiency of obtaining information.

In some scenes, the electronic device 110 may present an extended component when receiving the touch-and-hold operation of target media content by the user 140. The extended component includes a comment viewing control The electronic device 110 may superimposed present the comment associated with the target media content in the interface 200C after receiving the selection of the comment viewing control by the user 140.

Additionally or alternatively, as shown in FIG. 2A and FIG. 2D, the interface 200A includes the interaction content viewing control 260 associated with the first set of media contents 210. After the interaction content viewing control 260 is selected, the electronic device 110 may present the interface 200E. At this moment, the interface 200C includes a plurality of interaction contents associated with the first set of media contents 210.

In some embodiments, the electronic device 110 may, in response to receiving the third operation from the viewing interface, present a content list corresponding to the first set of media contents and a set of identification elements of a set of users corresponding to the first set of media contents in the viewing interface.

As an example, as shown in FIG. 2C and FIG. 2E, the electronic device 110 may present an interface 200E after the content viewing component 270 in the interface 200C is selected. The interface 200E includes the content list 280 corresponding to the first set of media contents and a set of identification elements 290.

Further, the electronic device 110 may display the media content added by the target user in the viewing interface in response to receiving a selection of the target identification element in a set of target identification elements. The target user corresponds to the target identification element.

As an example, as shown in FIG. 2E, the electronic device 110 may display the media content 285 added by the target user in the target style, after the target identification element 295 is selected by the user 140. The target style may be any suitable display style such as bolding or highlighting a border of the media content 285.

In some embodiments, the electronic device 110 adds the second media content into the first set of media contents to update the first content item. As an example, as shown in FIG. 2F, the electronic device 110 may add the second media content into the first set of media contents 210. After the second media content is added, the electronic device 110 may add the identification information of the user 140 into the component 215 to indicate the user 140 to participate in the editing of the first set of media contents 210. In this way, it can be presented more information associated with the set of media contents in the interface, thereby improving the efficiency of obtaining information.

In some embodiments, the electronic device 110 may switch the target interface to the second content item corresponding to the second set of media contents in response to receiving the fourth operation in the target interface. As an example, the electronic device 110 may receive a swiping operation by the user 140 in the interface 200F, and present the second content item corresponding to the second set of media contents in the interface 200F.

In some embodiments, the electronic device 110 may determine the reference information of the media content corresponding to at least one user. Further, the electronic device 110 may determine a display style of the identification information of at least one user based on the reference information. Finally, the electronic device 110 may present the identification information of at least one user based on a reality style.

As an example, the electronic device 110 may obtain reference information of a plurality of users associated with the first set of media contents 210 after the second media content is added into the first set of media contents 210. The reference information, for example, may be a contribution ratio of a plurality of users to the first media set of media contents 210 or the editing time of the plurality of users to the first media set of media contents 210. The contribution ratio indicates the number of the media content added into the first media set of media contents 210 by different users. Further, the electronic device 110 may determine the display style of a set of identification information corresponding to a plurality of users based on the reference information and display a set of identification information in the determined display style. The display style, for example, may be the size of the identification information.

In some scenes, as shown in FIG. 2F, the electronic device 110 may represent the identification information corresponding to the user with the highest contribution ratio in the largest size in the interface 200F.

In some embodiments, at least one user includes a plurality of users, the display style indicates the display priority of the identification information corresponding to the plurality of users.

As an example, the electronic device 110 may determine the display priority of the plurality of users based on the contribution ratio of the plurality of users. The display priority, for example, may be the order of a set of identification information displayed corresponding to the plurality of users. In such way, the disclosed embodiment can intuitively present the contribution ratio of the users who participate to edit the first set of media contents to the users.

In some embodiments, the display style of the first content item is determined based on the number of the media contents in the first set of media contents. As an example, as shown in FIG. 2F, the electronic device 110 may present the first content item in the style of multiple pictures superimposed when the first set of media contents includes a plurality of media contents.

In some embodiments, the first content item is determined based on the order of the addition of the media content in the first set of media contents. As an example, the electronic device 110 may present a media content lastly added into the first set of media contents 210 as the first content item and may also present the media content initially added into the first set of media contents 210 as the first content item.

In this way, the disclosed embodiment can support the users to make co-creations on the first media content, thereby improving the efficiency of creation of the first set of media contents.

### Example Process

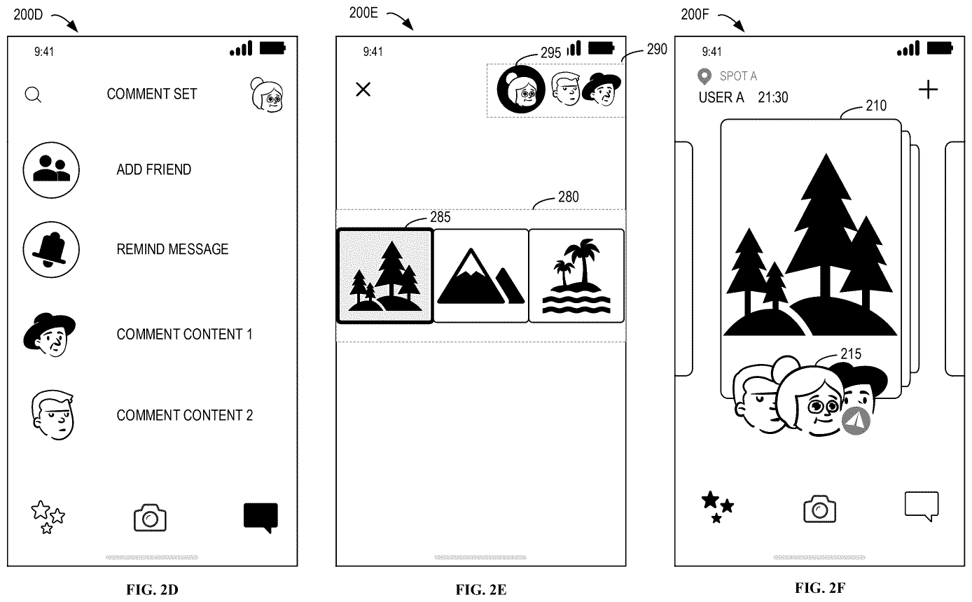

FIG. 3 illustrates a flowchart of an example process 300 for interface interaction according to some embodiments of the disclosure. The process 300 may be implemented at the electronic device 110. The process 300 is described below with reference to FIG. 1.

As shown in FIG. 3, at block 310, the electronic device 110 presents a first content item associated with a first set of media contents in a target interface. Presenting the first content item includes: displaying at least a first media content in the first set of media contents and identification information of at least one user which is associated with the first set of media contents.

At block 320, the electronic device 110 obtains a second media content associated with the current user in response to receiving an addition request associated with the first set of media contents.

At block 330, the electronic device 110 adds the second media content to the first set of media contents to update the first content item.

In some embodiments, the process 300 further includes: presenting an addition entry corresponding to the first set of media contents in the target interface or in a viewing interface of the first set of media contents; and obtaining the addition request associated with the first set of media contents in response to a selection of the addition entry.

In some embodiments, the process 300 further includes: presenting a viewing interface of the first set of media contents in response to a first operation for the first content item; and playing the first set of media contents in the viewing interface.

In some embodiments, the first set of media contents includes a plurality of media content, and playing the first set of media contents in the viewing interface includes: playing the first set of media contents based on a target play order, where the target play order is determined based on associated information of the plurality of media contents.

In some embodiments, the process 300 further includes: presenting a set of image identifications corresponding to the first set of media contents in the viewing interface; and presenting, in response to a selection of a target image identification in a set of image identification, the media content corresponding to the target image identification in the viewing interface.

In some embodiments, the process 300 further includes: providing an interaction control corresponding to the currently played target media content in the viewing interface; and triggering, in response to receiving an interaction operation associated with the target media content via the interaction control, sending of a remind message associated with the interaction operation to a user corresponding to the target media content.

In some embodiments, the process 300 further includes: presenting, in response to receiving a second operation in the viewing interface, an interaction message corresponding to a currently played target media content.

In some embodiments, the process 300 further includes: presenting, in response to receiving a third operation in the viewing interface, a content list corresponding to the first set of media contents and a set of identification elements of a set of users corresponding to the first set of media contents in the viewing interface; and displaying, in response to receiving a selection of a target identification element in the set of identification elements, a media content added by a target user in a target style in the viewing interface, the target user corresponding to the target identification element.

In some embodiments, the process 300 further includes: switching, in response to receiving a fourth operation in the target interface, the target interface to present a second content item corresponding to a second set of media contents.

In some embodiments, the process 300 further includes: determining reference information of the media content corresponding to at least one user; determining a display style of the identification information of the at least one user based on the reference information; presenting the identification information of the at least one user in the target interface based on the display style.

In some embodiments, at least one user includes a plurality of users, and the display style indicates the display priority of the identification information corresponding to the plurality of users.

In some embodiments, the display style of the first content item is determined based on the number of the media content in the first set of media contents.

In some embodiments, the first content item is determined based on the addition order of the media content in the first set of media contents.

In some embodiments, the first set of media contents is created based on a configuration operation of the target user, and obtaining the second media content associated with the current user in response to receiving the addition request associated with the first set of media contents includes: obtaining the second media content associated with the current user in response to the current user matching a user scope indicated by the configuration operation, the user scope indicating users allowed to add media content to the first set of media contents.

### Example Apparatus and Device

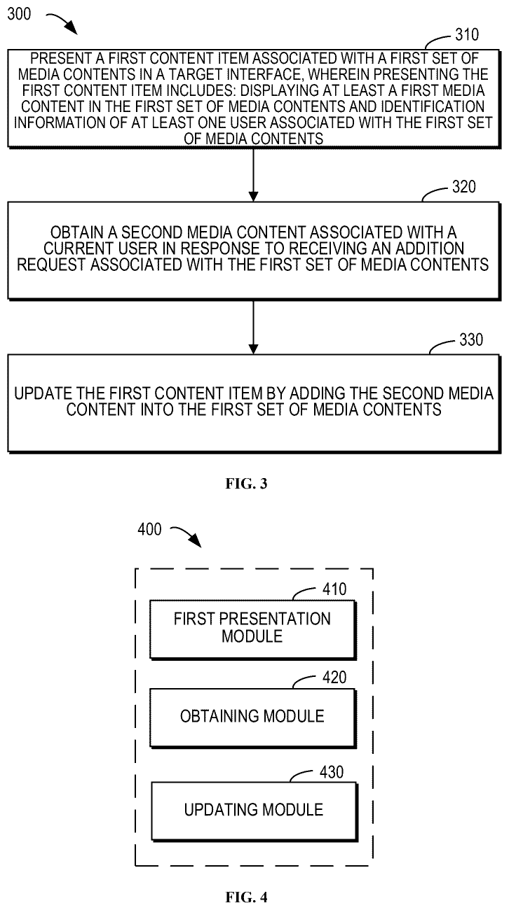

Embodiments of the present disclosure also provide a corresponding apparatus for implementing the above methods or processes. FIG. 4 illustrates a schematic structural block diagram of an example apparatus 400 for interface interaction in accordance with certain embodiments of the present disclosure. The apparatus 400 may be implemented as or included in an electronic device. The various modules/components in the apparatus 400 may be implemented by hardware, software, firmware, or any combination thereof.

As shown in FIG. 4, the apparatus 400 includes: a first presentation module 410 configured to present a first content item associated with a first set of media contents in a target interface, where presenting the first content item includes: displaying at least a first media content of the first set of media contents and identification information of at least one user associated with the first set of media contents; an obtaining module 420 configured to obtain a second media content associated with a current user in response to receiving an addition request associated with the first set of media contents; and an updating module 430 configured to update the first content item by adding the second media content to the first set of media contents.

In some embodiments, the apparatus 400 further includes an obtaining module configured to an addition entry corresponding to the first set of media contents in the target interface or in a viewing interface of the first set of media contents; and obtain the addition request associated with the first set of media contents in response to the selection of the addition entry.

In some embodiments, the apparatus 400 further includes a playing module configured to present a viewing interface of the first set of media contents in response to the first operation of the first content item; and play the first set of media contents in the viewing interface.

In some embodiments, the first set of media contents includes a plurality of media content. The playing module is further configured to play the first set of media contents based on the play order of the target, where the play order of the target is determined based on the associated information of the plurality of media contents.

In some embodiments, the apparatus 400 further includes a second presentation module configured to present a set of image identifications corresponding to the first set of media contents in the viewing interface; and present the media content corresponding to a target image identification in the viewing interface in response to the selection of the target image identification in the set of image identifications.

In some embodiments, the apparatus 400 further includes a triggering module configured to provide the interaction operation corresponding to the currently played target media content in the viewing interface; and trigger, in response to receiving an interaction operation associated with the target media content via the interaction control, sending of a remind message associated with the interaction operation to a user corresponding to the target media content.

In some embodiments, the apparatus 400 further includes a third presentation module configured to present, in response to receiving a second operation in the viewing interface, an interaction message corresponding to a currently played target media content.

In some embodiments, the apparatus 400 further includes a display module configured to present, in response to receiving a third operation in the viewing interface, a content list corresponding to the first set of media contents and a set of identification elements of a set of users corresponding to the first set of media contents in the viewing interface; and display, in response to receiving a selection of a target identification element in the set of identification elements, a media content added by a target user in a target style in the viewing interface, the target user corresponding to the target identification element.

In some embodiments, the apparatus 400 further includes a switch module configured to switch, in response to receiving a fourth operation in the target interface, the target interface to present a second content item corresponding to a second set of media contents.

In some embodiments, the apparatus 400 further includes a determination module configured to determine reference information of the media content corresponding to at least one user; determine a display style of the identification information of at least one user based on the reference information; and present the identification information of at least one user in the target interface based on the display style.

In some embodiments, at least one user includes a plurality of users, and the display style indicates the display priority of the identification information corresponding to the plurality of users.

In some embodiments, the display style of the first content item is determined based on the number of the media content in the first set of media contents.

In some embodiments, the first content item is determined based on the addition order of the media content in the first set of media contents.

In some embodiments, the first set of media contents is created based on a configuration operation of the target user, the obtaining module 420 is further configured to obtain the second media content associated with current user in response to the current user matching a user scope indicated by the configuration operation, the user scope indicating users allowed to add media content to the first set of media contents.

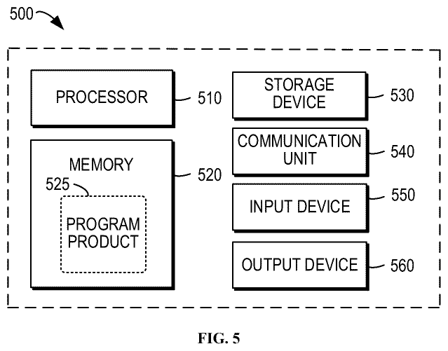

As shown in FIG. 5, the electronic device 500 is in the form of a general-purpose electronic device. Components of the electronic device 500 may include, but are not limited to, one or more processors or processing units 510, a memory 520, a storage device 530, one or more communication units 540, one or more input devices 550, and one or more output devices 560. The processing unit 510 may be an actual or virtual processor and capable of performing various processes according to programs stored in the memory 520. In multiprocessor systems, multiple processing units execute computer-executable instructions in parallel to improve the parallel processing capability of electronic device 500.

The electronic device 500 typically includes a plurality of computer storage media. Such media may be any available media accessible by the electronic device 500, including, but not limited to, volatile and non-volatile media, removable and non-removable media. The memory 520 may be a volatile memory (e.g., a register, a cache, a random-access memory (RAM)), a non-volatile memory (e.g., read-only memory (ROM), an electrically erasable programmable read-only memory (EEPROM), flash memory), or some combination thereof. A storage device 530 may be a removable or non-removable medium and may include a machine-readable medium, such as a flash drive, a magnetic disk, or any other medium, which may be used to store information and/or data and may be accessed within the electronic device 500.

The electronic device 500 may further include additional removable/non-removable, volatile/non-volatile storage media. Although not shown in FIG. 5, a disk drive for reading from or writing to a removable, nonvolatile magnetic disk such as a “floppy disk” and an optical disk drive for reading from or writing to a removable, nonvolatile optical disk may be provided. In these cases, each drive may be connected to a bus (not shown) by one or more data media interfaces. The memory 520 may include a computer program product 525 having one or more program modules configured to perform various methods or actions of various embodiments of the present disclosure.

The communications unit 540 implements communications with other electronic devices over a communications medium. Additionally, the functionality of components of the electronic device 500 may be implemented in a single computing cluster or a plurality of computing machines capable of communicating over a communication connection. Thus, the electronic device 500 may operate in a networked environment using logical connections to one or more other servers, network personal computers (PCs), or another network node.

The input device 550 may be one or more input devices such as a mouse, a keyboard, a trackball, or the like. The output device 560 may be one or more output devices, such as a display, a speaker, a printer, or the like. The electronic device 500 may also communicate with one or more external devices (not shown) such as a storage device, a display device, or the like through the communication unit 540 as required, and communicate with one or more devices that enable a user to interact with the electronic device 500, or communicate with any device (e.g., a network card, a modem, or the like) that enables the electronic device 500 to communicate with one or more other electronic devices. Such communication may be performed via an input/output (I/O) interface (not shown).

According to exemplary implementations of the present disclosure, there is provided a computer-readable storage medium having computer instructions stored thereon, where the computer instructions are executed by a processor to implement the method described above. In accordance with exemplary implementations of the present disclosure, there is also provided a computer program product, and the computer program product is tangibly stored on a non-transient computer-readable medium and includes computer-executable instructions, and the computer-executable instructions are executed by the processor to implement the above-described method.

Aspects of the present disclosure are described herein with reference to flowcharts and/or block diagrams of methods, apparatuses, devices and computer program products implemented in accordance with the present disclosure. It will be understood that each block of the flowcharts and/or block diagrams and combinations of blocks in the flowchart and/or block diagrams can be implemented by computer readable program instructions.

These computer readable program instructions may be provided to a processing unit of a general-purpose computer, special purpose computer, or other programmable data processing apparatus to produce a machine, such that the instructions, which execute via the processing unit of the computer or other programmable data processing apparatus, create means for implementing the functions/actions specified in one or more blocks of the flowchart and/or block diagrams. These computer readable program instructions may also be stored in a computer readable storage medium that can direct a computer, a programmable data processing apparatus, and/or other devices to function in a particular manner, such that the computer readable medium storing the instructions includes an article of manufacture including instructions which implement various aspects of the functions/actions specified in one or more blocks of the flowchart and/or block diagrams.

The computer readable program instructions may also be loaded onto a computer, other programmable data processing apparatus, or other devices, causing a series of operational steps to be performed on a computer, other programmable data processing apparatus, or other devices, to produce a computer implemented process such that the instructions, when being executed on the computer, other programmable data processing apparatus, or other devices, implement the functions/actions specified in one or more blocks of the flowchart and/or block diagrams.

The flowcharts and block diagrams in the drawings illustrate the architecture, functionality, and operations of possible implementations of the systems, methods, and computer program products according to various implementations of the present disclosure. In this regard, each block in the flowchart or block diagram may represent a module, segment, or portion of instructions which includes one or more executable instructions for implementing the specified logical function(s). In some replaced implementations, the functions marked in the blocks may occur in a different order than those marked in the drawings. For example, two consecutive blocks may actually be executed in parallel, or they may sometimes be executed in reverse order, depending on the function involved. It should also be noted that each block in the block diagrams and/or flowcharts, as well as combinations of blocks in the block diagrams and/or flowcharts, may be implemented using a dedicated hardware-based system that performs the specified function or operations, or may be implemented using a combination of dedicated hardware and computer instructions.

Various implementations of the disclosure have been described as above, the foregoing description is exemplary, not exhaustive, and the present application is not limited to the implementations as disclosed. Many modifications and variations will be apparent to those of ordinary skill in the art without departing from the scope and spirit of the implementations as described. The selection of terms used herein is intended to best explain the principles of the implementations, the practical application, or improvements to technologies in the marketplace, or to enable those skilled in the art to understand the implementations disclosed herein.

What is claimed is:

1. A method for interface interaction, comprising:
presenting a first content item associated with a first set of media contents in a target interface, wherein presenting the first content item comprises: displaying at least a first media content in the first set of media contents and identification information of at least one user associated with the first set of media contents;
obtaining a second media content associated with a current user in response to receiving an addition request associated with the first set of media contents; and
updating the first content item by adding the second media content into the first set of media contents.

2. The method of claim 1, further comprising:
presenting an addition entry corresponding to the first set of media contents in the target interface or in a viewing interface of the first set of media contents; and
obtaining the addition request associated with the first set of media contents in response to a selection of the addition entry.

3. The method of claim 1, further comprising:
presenting a viewing interface of the first set of media contents in response to a first operation for the first content item; and
playing the first set of media contents in the viewing interface.

4. The method of claim 3, wherein the first set of media contents comprises a plurality of media contents, and playing the first set of media contents in the viewing interface comprises:
playing the first set of media contents based on a target play order, wherein the target play order is determined based on associated information of the plurality of media contents.

5. The method of claim 3, further comprising:
presenting a set of image identifications corresponding to the first set of media contents in the viewing interface; and
presenting, in response to a selection of a target image identification in the set of image identifications, media content corresponding to the target image identification in the viewing interface.

6. The method of claim 3, further comprising:
providing, in the viewing interface, an interaction control corresponding to a target media content currently played; and
triggering, in response to receiving an interaction operation associated with the target media content via the interaction control, sending of a remind message associated with the interaction operation to a user corresponding to the target media content.

7. The method of claim 3, further comprising:
presenting, in response to receiving a second operation in the viewing interface, an interaction message corresponding to a currently played target media content.

8. The method of claim 3, further comprising:
presenting, in response to receiving a third operation in the viewing interface, a content list corresponding to the first set of media contents and a set of identification elements of a set of users corresponding to the first set of media contents in the viewing interface; and
displaying, in response to receiving a selection of a target identification element in the set of identification elements, a media content added by a target user in a target style in the viewing interface, the target user corresponding to the target identification element.

9. The method of claim 1, further comprising:
switching, in response to receiving a fourth operation in the target interface, the target interface to present a second content item corresponding to a second set of media contents.

10. The method of claim 1, further comprising:
determining reference information of media content corresponding to the at least one user;
determining a display style of the identification information of the at least one user based on the reference information; and
presenting the identification information of the at least one user in the target interface based on the display style.

11. The method of claim 10, wherein the at least one user comprises a plurality of users, and the display style indicates display priority of the identification information corresponding to the plurality of users.

12. The method of claim 1, wherein a display style of the first content item is determined based on the number of media contents in the first set of media contents.

13. The method of claim 1, wherein the first content item is determined based on an addition order of media contents in the first set of media contents.

14. The method of claim 1, wherein the first set of media contents is created based on a configuration operation of a target user, and obtaining the second media content associated with the current user in response to receiving the addition request associated with the first set of media contents comprising:
obtaining the second media content associated with the current user in response to the current user matching a user scope indicated by the configuration operation, the user scope indicating users allowed to add media content to the first set of media contents.

15. An electronic device, comprising:
at least one processor; and
at least one memory coupled to the at least one processor and storing instructions for execution by the at least one processor, the instructions, when executed by the at least one processor, causing the electronic device to:
present a first content item associated with a first set of media contents in a target interface, wherein presenting the first content item comprises: displaying at least a first media content in the first set of media contents and identification information of at least one user associated with the first set of media contents;
obtain a second media content associated with a current user in response to receiving an addition request associated with the first set of media contents; and
update the first content item by adding the second media content into the first set of media contents.

16. The electronic device of claim 15, wherein the instructions, when executed by the at least one processor, further cause the electronic device to:
present an addition entry corresponding to the first set of media contents in the target interface or in a viewing interface of the first set of media contents; and
obtain the addition request associated with the first set of media contents in response to a selection of the addition entry.

17. The electronic device of claim 15, wherein the instructions, when executed by the at least one processor, further cause the electronic device to:
present a viewing interface of the first set of media contents in response to a first operation for the first content item; and
play the first set of media contents in the viewing interface.

18. The electronic device of claim 15, wherein the instructions, when executed by the at least one processor, further cause the electronic device to:
determine reference information of media content corresponding to the at least one user;
determine a display style of the identification information of the at least one user based on the reference information; and
present the identification information of the at least one user in the target interface based on the display style.

19. A non-transitory computer readable storage medium having a computer program stored thereon, the computer program being executable by a processor to implement acts comprising:
presenting a first content item associated with a first set of media contents in a target interface, wherein presenting the first content item comprises: displaying at least a first media content in the first set of media contents and identification information of at least one user associated with the first set of media contents;
obtaining a second media content associated with a current user in response to receiving an addition request associated with the first set of media contents; and
updating the first content item by adding the second media content into the first set of media contents.

20. The non-transitory computer readable storage medium of claim 19, wherein the acts further comprises:
presenting a viewing interface of the first set of media contents in response to a first operation for the first content item; and
playing the first set of media contents in the viewing interface.
